(19) United States
(12) Patent Application Publication
(10) Pub. No.: US 2018/0192679 A1
(43) Pub. Date: Jul. 12, 2018

(54) CRYSTAL COMESTIBLE PRODUCT AND METHOD OF MAKING SAME

(71) Applicant: Fresh Origins, LLC, San Marcos, CA (US)

(72) Inventors: David G. Sasuga, Vista, CA (US); Ju Won Park, Los Angeles, CA (US)

(21) Appl. No.: 15/912,194

(22) Filed: Mar. 5, 2018

Related U.S. Application Data
(63) Continuation of application No. 14/174,837, filed on Feb. 6, 2014, now abandoned.
(60) Provisional application No. 61/762,160, filed on Feb. 7, 2013.

(51) Int. Cl. A23L 27/10; C13B 50/00; C13B 30/02; A23L 27/40; A23L 27/14; A23L 27/00; A23G 3/48

(52) U.S. Cl. CPC A23L 27/10; C13B 50/002; C13B 30/021; A23G 3/48; A23L 27/14; A23L 27/70; A23L 27/40

(57) ABSTRACT

A crystal comestible product and method of making it are provided. The crystal comestible product is suitable for use as a food additive, a flavor additive, a nutritional additive, and decoration. The crystal comestible product includes a matrix of edible crystals surrounding air pockets and free spaces, providing a light crunchy crispy texture. The crystal comestible product may include ingredients that add flavor, color, nutritional value, texture, structure, or stability. Suitable ingredients include fresh herbs, fresh flowers, spices, natural and synthetic flavors, nuts, vitamins and minerals.

### CROSS REFERENCE TO RELATED APPLICATIONS

The present application claims the benefit of and priority to U.S. Non-Provisional patent application Ser. No. 14/174,837, filed Feb. 6, 2014, entitled “CRYSTAL COMESTIBLE PRODUCT AND METHOD OF MAKING SAME,” that claims priority to U.S. Provisional Patent Application No. 61/762,160, filed Feb. 7, 2013, entitled “CRYSTAL COMESTIBLE PRODUCT AND METHOD OF MAKING SAME,” and each of these patent applications is herein incorporated by reference in its entirety.

### FIELD OF THE INVENTION

The present invention relates in general to crystal comestible products and methods for making them. It more particularly relates to such a crystal comestible product and method for providing a novel good tasting comestible product containing a crystal substance such, for example, as sugar, salt and/or others.

### BACKGROUND ART

This section describes the background art of the disclosed embodiment of the present invention. There is no intention, either express or implied, that the background art discussed in this section legally constitutes prior art.

There have been used a variety of condiments to provide added flavor and zest to foods. It would be desirable to have a new and improved comestible, which would serve, for example, as a condiment or other food item which would add a desirable mouth feel and even color or taste to a wide variety of foods and even beverages.

### CERTAIN EMBODIMENTS OF THE INVENTION

A method of making a comestible product is provided comprising the steps of combining an amount of moisture comprising a solvent with a quantity of edible crystals to partially dissolve the edible crystals in the solvent to form a slurry solution having entrained air spaces, entrained edible crystal material in the form of dissolved, partially dissolved, and undissolved edible crystals, and solvent; greatly inhibiting or stopping further edible crystal dissolution and promoting formation of new crystals that bond the edible crystal material, and trap solvent and pockets of air within a substantially crystalline matrix of edible crystals; and removing some or all of the solvent from the matrix to yield a crystal comestible product comprising air pockets that were trapped within the matrix, free space created by removing some or all of the solvent, and a matrix of substantially crystalline material formed around the air pockets and free spaces.

A method of making a comestible product, comprising the steps of combining moisture with edible crystals; wherein the moisture comprises a solvent; and wherein the combining at least partially dissolves at least some of the edible crystals in the solvent to form a slurry having entrained air spaces and entrained edible crystal material; inhibiting or stopping further edible crystal dissolution in the slurry by removing some or all of the solvent to cause formation of additional entrained air spaces; dissolved, partially dissolved, and undissolved edible crystals; and any remaining solvent to promote formation of re-formed crystals that bond together the edible crystals; and forming re-formed crystals that bond together the edible crystals; and wherein the inhibiting or stopping includes extruding the slurry to separate therefrom particles of predetermined sizes of the edible crystal material; and drying the extruded predetermined sized particles to remove some or all of moisture therefrom by one or more of the following: increasing temperature of the extruded particles, exposing the extruded particles to a vacuum, reducing humidity of the atmosphere surrounding the extruded particles, air drying the extruded particles, freeze drying the extruded particles; and blowing ambient air across a surface of the extruded particles, wherein the combining moisture with edible crystals step further includes including adding an amount of moisture above a critical amount to prevent partially dissolved crystals to not combine evenly and not enough crystals dissolving, and below a critical amount to prevent an undesirable dissolving of the crystals and displacing air pockets with moisture; and wherein the inhibit or stopping creates a crystalline matrix of edible crystals that is formed around the solvent and air spaces for providing the resulting comestible product with a flaky crispy airy crunchable texture to achieve a desirable mouth feel as compared to the texture and mouth feel of the undissolved edible crystals.

A crystal comestible product having a crunchy crispy texture, and methods of making a crystal comestible product having a crunchy crispy texture, are provided herein. A crystal comestible product suitable for use as a food additive, a flavor additive, or a nutritional additive is provided herein. A crystal comestible product as provided herein, can be produced as small particles or formed into edible objects.

According to an exemplary, non-limiting embodiment, a crystal comestible product and a method of making it relate to an edible crystal and a solvent that are combined under conditions such that the edible crystal is partially dissolved in the solvent, after which new crystals are allowed to re-form to bond air pockets, solvent, and re-formed crystals together, after which some of all of the solvent is removed, forming a crispy crunchy airy comestible product as provided herein.

According to a further exemplary, non-limiting embodiment, there is provided a method of making a crystal comestible product by combining by means of admixing, agitating, amalgamating, or otherwise mixing a critical amount of moisture comprising a solvent with a quantity of edible crystals to begin dissolving the edible crystals in the solvent to form a slurry solution. The slurry solution may include entrained air spaces, entrained edible crystal material in the form of dissolved, partially dissolved, and undissolved edible crystals (i.e, dissolved, partially dissolved, and undissolved edible crystal material), and solvent, combined with the solvent under conditions that allow new crystals of the edible crystal to form, bonding the edible crystal material and trapping solvent and pockets of air within a substantially crystalline matrix of edible crystals, after which some or all of the solvent is removed to yield a crystal comestible product as provided herein. It is understood that by “substantially crystalline edible crystal matrix” it is meant that the edible crystal matrix may include the edible crystal material in semicrystalline, amorphous, or amalgam forms, in addition to edible crystals in crystalline form. Other ingredients present in the slurry solution may also be trapped within the edible crystal matrix.

In another exemplary, non-limiting embodiment, there is provided a method of making a crystal comestible product by combining by means of admixing, agitating, amalgamating, or otherwise mixing a critical amount of moisture comprising a solvent with a quantity of edible crystals to begin dissolving the edible crystals in the solvent to form a slurry solution that may include entrained air spaces, entrained edible crystal material in the form of dissolved, partially dissolved, and undissolved edible crystals, and solvent. Further dissolution of the edible crystals in solvent is greatly inhibited or stopped and formation of new crystals is promoted. Formation of new crystals bonds the edible crystal material, and traps solvent and pockets of air within a substantially crystalline matrix of edible crystals. In accordance with this embodiment, dissolved, partially dissolved, and undissolved edible crystal material is combined with the solvent under conditions that allow new crystals of the edible crystal to form, bonding the edible crystal material and trapping solvent and pockets of air within a substantially crystalline matrix of edible crystals.

Conditions that allow formation of new crystals of the edible crystal can include conditions that greatly inhibit or stop further dissolution of the edible crystals in the solvent, as well as conditions that promote formation of new crystals and bonding of the edible crystal material to form the edible crystal matrix. In one embodiment, conditions that greatly inhibit or stop further dissolution of the edible crystals in the solvent are different from conditions that promote formation of new crystals and bonding of the edible crystal material to form the edible crystal matrix.

The edible crystal matrix is treated to remove some or all of the solvent, and if necessary to remove some or all of other components of moisture present in the matrix, leaving additional air pockets or other free spaces where solvent was previously found, to yield a crystal comestible product as provided herein. The crunchy crystal comestible as provided herein can be characterized as light and crunchy, and has a characteristic texture due to factors that may include, but are not limited to, air pockets that were trapped within the edible crystal matrix as it formed, additional air pockets or other free space created by removing some or all of the solvent, and other components of moisture, from the edible crystal matrix, and the remaining matrix of substantially crystalline material formed around these air pockets or free spaces. The texture of a crunchy crystal comestible as provided herein may vary according to the type or types of edible crystals used, the solvent or solvents used, any other moisture components present in the slurry solution, the solvent/moisture content of the slurry solution, the mixing and aeration of the slurry solution, the amount of dissolution of the edible crystals that occurred, the amount of solvent/moisture removed, the presence of other ingredients such as flavor, color, nutritional, or structural ingredients that may affect the formation of the edible crystal matrix, and the ways edible matrix was handled to form the crystal comestible product.

In one non-limiting embodiment, greatly inhibiting or stopping further edible crystal dissolution and promoting formation of new crystals that bond the edible crystal material, and trap solvent and pockets of air within a substantially crystalline matrix of edible crystals, is achieved during removal of solvent, whereby as the concentration of solvent declines, no more dissolution occurs and more of the dissolved and partially dissolved edible crystal material comes out of solution and can re-form crystals.

In a non-limiting embodiment, conditions such that new crystals of the edible crystal begin to form, bonding the edible crystal material and trapping solvent and pockets of air within a substantially crystalline matrix of edible crystals, are created during removal of some or all of the solvent, and if necessary to remove some or all of other components of moisture present in the matrix, where new crystals of the edible crystal begin to form as solvent is removed, bonding the edible crystal material and trapping pockets of air, free spaces created by removing some or all of the solvent and if necessary free spaces created by removing other components of moisture, within a substantially crystalline matrix of edible crystals.

In a non-limiting embodiment, the slurry solution is placed directly into molds or shaped into objects under conditions that greatly inhibit or stop further dissolution of the edible crystals in the solvent, and promote formation and bonding of new crystals to form an edible crystal matrix, followed by removal of solvent, and other moisture components if necessary to produce light crunchy crystal comestible products.

The slurry solution may include entrained air spaces, entrained edible crystal material in the form of dissolved, partially dissolved, and undissolved edible crystals, and solvent, whereby the dissolved, partially dissolved, and undissolved edible crystal material is combined with the solvent under conditions such that new crystals of the edible crystal begin to form, bonding the edible crystal material and trapping solvent and pockets of air within a substantially crystalline matrix of edible crystals.

According to a further exemplary, non-limiting embodiment, mixtures are extruded from the slurry solution and manipulated to greatly inhibit or stop further crystal dissolution to obtain a desired crystal comestible product as provided herein. In an exemplary, non-limiting embodiment, predetermined sized particles are extruded from the slurry solution by passing slurry solution through a mesh, sieve, or screen with pores of predetermined size, which serves to inhibit greatly or stop further crystal dissolution by separating the particles to facilitate drying to remove some or all of the solvent from the extruded mixture, and promote further formation and bonding of crystals to form an edible crystal matrix. Extruded mixtures such as the extruded predetermined size particles described herein, are caused to dry to form the light, crunchy crystal comestible product. In another non-limiting embodiment, extruded mixtures are molded or shaped into objects that are dried to remove some or all of the solvent from the extruded mixture, and promote further formation and bonding of crystals in the light, crunchy crystal comestible product.

According to a further exemplary, non-limiting embodiment, the slurry solution including entrained edible crystal material in the form of dissolved, partially dissolved, and undissolved edible crystals, and solvent may further contain ingredients that do not dissolve in the solvent, wherein such ingredients can be incorporated during formation and bonding of new crystals from the dissolved, partially dissolved, and undissolved edible crystal material, or can be trapped in pockets of air formed during formation and bonding of new crystals in the edible crystal matrix. Yet another exemplary, non-limiting embodiment relates in general to such a crispy crunchy crystal comestible product containing edible crystal matrix formed by partial dissolution in a solvent followed by drying to remove some or all of the solvent, where the edible crystal matrix contains one or more edible crystals is derived from a salt or sugar or related substance. As provided herein, the term “sugar” is understood to refer to one or more sweetening agents that can be obtained in crystalline or semicrystalline form including, but not limited to, sucrose, fructose, glucose, mannose, lactose, maltose, dextrose, levulose, inulin, tagatose, trehalose, sugars derived from plant sources such as agave sugar, beet sugar, maple sugar, cane sugar, date sugar, stevia sugar (stevia crystal, steviol glycoside, rebaudioside), luo han guo sugar, sugar crystallized from honey, sugar crystallized from syrup or molasses, powdered fruit juices such as powdered orange juice, powdered apple juice, powdered grape juice, so-called artificial sweeteners or synthetic sugars such as sucralose, aspartame, neotame, acesulfame potassium, saccharin, sugar alcohols such as erythritol, isomalt, lactitol, maltitol, mannitol, sorbitol, xylitol, sugars with attached groups including but not limited to terpenes or ester groups, where two or more sweetening agents may mechanically mixed, co-crystallized, or otherwise combined. As provided herein, the term “salt” is understood to refer to edible, food-safe complexes of at least two components that can be obtained in crystalline or semicrystalline form and are not considered to have a sweet taste, including but not limited to, sodium chloride (“table salt”), potassium chloride, calcium chloride, iodized sodium chloride (“iodized salt”), “rock salt” (sodium chloride containing additional impurities), where two or more salts may be mechanically mixed, co-crystallized, or otherwise combined. As provided herein, “salt” and “sugar” ingredients may be combined, e.g., by mechanical mixing or co-crystallization,

A further exemplary, non-limiting embodiment relates to the moisture comprising a solvent such as water or other solvent in which an edible crystal can dissolve, fully or partially, to form a slurry solution. Moisture, as provided herein, may include other components beside the solvent(s) in which the edible crystal(s) dissolves. The moisture may be in liquid, gas, or vapor form, and further wherein some or all of the solvent, and any other moisture components as desired, can be removed from the slurry solution to yield a crystal comestible product. Exemplary embodiments of moisture comprising a solvent include but are not limited to water, non-aqueous solvents such as ethanol and ethanol-containing products including but not limited to wine, beer, malt beverages, distilled spirits such as vodka, rum, brandy, or liqueurs, extracts such as vanilla or almond extract, other non-aqueous solvents such as dimethyl sulfoxide (DMSO), mixtures of non-aqueous solvents, and mixtures of water with one or more non-aqueous solvents. Exemplary embodiments of removing of some or all of the moisture from a mixture extruded from a slurry solution as provided herein, also referred to drying, include but are not limited to, drying by increasing the surface area of components of the extruded mixture that are exposed to air to promote evaporation, drying by increasing the temperature of the extruded mixture, drying by placing the extruded mixture under vacuum, and drying by reducing the humidity of the surrounding atmosphere using dessicants.

Still a further embodiment relates to the moisture being provided by an edible substance that contains water or other liquid that may serve as a solvent. The edible substance may be a naturally occurring substance such as fennel, basil, and mint, or combinations thereof, or any other herb, spice, flavoring agent, or food additive, any of which may provide moisture as liquid water, water vapor, cell contents, intercellular water or other liquids, water or other liquids bound to or otherwise associated with substance surfaces, and oils and waxes. Other edible substances may include cocoa, edible flowers such as roses, or others. Moisture may be released as necessary from an edible substance by methods including but not limited to, freezing the edible substance to rupture cells or other structures, mechanical disruption of the edible substance by methods such as grinding using a pestle and mortar, macerating, chopping, cutting, blending, or agitating in a container with beads, or osmotic methods such as exposing the edible substance to an external osmotic agent to draw moisture out of the substance. Other ingredients may be included as a source of some of not all moisture, for example, adhesives included in the slurry, or foods such as nuts. If the edible substance does not contain sufficient moisture or is not used at all, a suitable vehicle such as water or other liquid that may serve as a solvent may be added to the slurry solution.

The amount and kind of moisture to be used in the compositions and methods provided herein, can be determined by one of skill in the art. Moisture levels, where moisture may consist only of the solvent(s) used to dissolve the edible crystal(s) or may comprises additional components. Moisture levels can be selected to allow the edible crystal(s) to partially dissolve to the desired degree, while also promoting conditions that greatly inhibit or stop further dissolution of the edible crystals in the solvent, and/or conditions that promote formation of new crystals and/or bonding of the edible crystal material to form the edible crystal matrix. In a non-limiting exemplary embodiment, moisture levels measured as water content are kept as low as possible to inhibit further dissolution and promote formation of new crystals and bonding, while being sufficient to allow partial dissolution of edible crystal in solvent. In another non-limiting exemplary embodiment, lower moisture levels are used in order to facilitate the removal of some of all of the solvent, and other moisture components if necessary, during preparation of the crystal comestible product as provided herein. In a non-limiting exemplary embodiment, water at between 5 to 15% by volume can be mixed with sugar (sucrose) at between 85 to 95% by volume to form a slurry solution in which the sugar can partially dissolve as desired, and water can later be removed by drying, to yield a crystal comestible product as provided herein. In a further non-limiting exemplary embodiment, an ingredient with lower moisture content can be selected to prepare a crystal comestible product, for example, fennel flowers with lower water content may be preferable over violet flowers with higher water content for certain products or processes. In a further non-limiting exemplary embodiment, an ingredient with higher moisture content can be selected to prepare a crystal comestible product, for example, basil leaves with higher water content may be preferable over oregano leaves with lower water content for certain products or processes.

Slurry solutions as provided herein are understood to include at least an amount of moisture comprising a solvent and a quantity of edible crystals, that are admixed, agitated, blended, beaten, compounded, or otherwise mixed under conditions for partially dissolving the edible crystals to form a slurry solution. Slurry solutions as provided herein may further include one or more edible substances that may provide one or more functions such as solvent, flavor, color, nutrition, structure, texture, bonding, or stability.

In one non-limiting exemplary embodiments, slurry solution is used to make crystal comestible products as provided herein. For example, slurry solution can be poured into a mold and some or all of the moisture is removed to make a crystal comestible product having a desired shape, size, and texture. Removing of some or all of the moisture from a slurry solution as provided herein, also referred to drying, can be accomplished by methods including but are not limited to, drying by increasing the surface area of components of the slurry solution that are exposed to air to promote evaporation, drying by blowing ambient air or heated air over the slurry solution, drying by increasing the temperature of the slurry solution, drying by placing the slurry solution under vacuum, freeze-drying, or drying by reducing the humidity of the surrounding atmosphere using dessicants, or forced air or dehumidified air, where the dehumidified air can be heated, ambient temperature, or cooled. Solvents can be selected for their ease of removal to facilitate drying, e.g., ethanol has a lower boiling point than water, and may therefore be easier to remove by drying or gentle heating a lower temperature than water. Moisture components may be selected for the ability to contribute to the ease of removing some or all of the solvent, and other moisture components as necessary, for example, components may be included such that a mixture of the component with the solvent may lower the vapor pressure or boiling point of the mixture, making the solvent easier to remove, or components that have a drying function can be included. Slurry solutions may be prepared with lower or higher moisture levels in order to facilitate drying of molded slurry solution to produce a crystal comestible product having a desired shape, size, and texture. Solvent, other moisture components, and other ingredients may be selected for ease of removing some or all solvent and/or moisture in order to facilitate drying of molded slurry solution to produce a crystal comestible product having a desired shape, size, and texture.

In another non-limiting exemplary embodiment, slurry solution can be extruded and the extruded mixture can be used to make crystal comestible products as provided herein. For example, slurry solution extruded and some or all of the moisture is removed from the extruded mixture to make a crystal comestible product having a desired shape, size, and texture. Extruding mixture from a slurry solution containing partially dissolved crystals as provided herein can be accomplished by methods including but not limited to passing slurry through a mesh, screen, or sieve to form particles having predetermined sizes according to opening size in the mesh, screen, or sieve used for extrusion, using a nozzle or fixed opening size extruding device, blowing or propelling slurry to form particles of homogeneous or heterogenous sizes that are deposited on a surface, preferably a non-stick surface, or introduced into an airstream or air chamber, or introduced into a flash dryer or heating device, or into a mold, using forming extruders, or using mixing extruders that may permit inclusion of additional ingredients after slurry formation. Extrusion methods as provided herein may provide additional drying functions. Extrusion methods as provided herein, may be selected to include functions such as aeration of the extruded mixture to further promote incorporation of air in the crystal comestible product. Further processing after extrusion may be used to decrease particle size, for example, material extruded through a mesh, sieve, or screen, can then be put through a spinning blade to chop the extruded material into even smaller particles, or by using compression to further break particles into smaller sizes. Removing of some or all of the moisture from a mixture extruded from a slurry solution as provided herein, also referred to drying, can be accomplished by methods including but are not limited to, drying by increasing the surface area of components of the extruded mixture that are exposed to air to promote evaporation, drying by blowing ambient air or heated air over the extruded mixture, drying by increasing the temperature of the extruded mixture, drying by placing the extruded mixture under vacuum, freeze-drying, and drying by reducing the humidity of the surrounding atmosphere using dessicants. Solvents can be selected for their ease of removal, e.g., ethanol has a lower boiling point than water, and may therefore be easier to remove by drying or gentle heating a lower temperature than water. Moisture components may be selected for the ability to contribute to the ease of removing some or all of the solvent, and other moisture components as necessary, for example, components may be included such that a mixture of the component with the solvent may lower the vapor pressure or boiling point of the mixture, making the solvent easier to remove. In another non-limiting embodiment, additional ingredients may be introduced into, or layered on, coated on, sprayed on, or powdered on, particles during or after drying, for example to add additional flavor, color, or texture.

A crystal comestible product as provided herein may be formed using only edible crystals and solvent, or may be formed with one or more additional ingredients that may add one or more features including but not limited to flavor, color, nutrition, structure, texture, stability, and suitability for designated uses. Ingredients may provide more than one feature, for example herbs, flowers, or spices may provide flavor and color and nutrition to the product and may, depending of the form of the ingredient that used, provide moisture (solvent), texture, and stability, and furthermore, may contribute to making the product suitable for a designated use such as molding or baking.

When the crystal comestible product is formed without the use of flavor enhancing substances, the resulting comestible product is a light, airy, flaky crispy crunchy product which may enhance the taste and texture of foods and beverages or may be eaten separately. When the crystal comestible product is derived from sugar or a related substance or combination of substances, the product may be used by pastry chefs for desserts to provide a unique texture for enhancing mouth feel when the dessert is eaten. This product can also be used as a sweetener for hot tea or other beverages. Another example of its use is as a “rimming” sugar for use on cocktail glasses to impart a sweet flavor and crispy texture compared to existing hard single crystal rimmers to the cocktail.

When the crystal comestible product is derived from salt or a related substance or combination of substances, the crispy crunchy salt product may be used as a “finishing” salt for cocktail glasses or the like when serving alcoholic beverages. Sweet and salty tasting substances may also be combined to create a crystal comestible product of different tastes. In general, there are many possible uses for the new comestible product. Such uses may include enhancing the taste, appearance and/or texture of beverages, desserts, salads, savory dishes and others.

A crystal comestible product as provided herein may include one or more flavors or flavor enhancing substances, including but not limited to, herbs, herb flavors, flowers, flower flavors, spices, spice flavors, nuts, nut flavors, other foods, other food flavors. Flavors or flavor enhancing substances as provided herein may including but not limited to, basil, mint, cilantro, tarragon, oregano, rosemary, thyme, rose, fennel, hibiscus, cranberry, blueberry, apple, lemon, orange, pineapple, pumpkin, “pumpkin pie spice” blend, coffee, chocolate, vanilla, cinnamon, mace, nutmeg, sasparilla, saffron, truffle, almond, peanut, pecan, walnut, chili pepper, barbeque flavor, cheese flavor, bacon flavor. Flavors or flavor enhancing substances may be supplied by edible substances or foods of plant, fungal, or animal origin, such as leaves, flowers, stalks, seeds, fruits, whole plants, bark, mushrooms, fish, cheese, nuts, meat, or bacon, where the edible substances or foods may be fresh or dried, e.g., fresh fruit or dried fruits. Flavors or flavor enhancing substances may be supplied by extracts, blends, and synthetic flavor products. A crystal comestible product as provided herein may include one or more colors, coloring agents, or color enhancing substances, including but not limited to, colors provided by edible substances such as flowers, herbs, or spices included in the product, colors provided by so-called natural food dyes such as caramel coloring, annatto, chlorophyllin, cochineal, betanin, turmeric, saffron, paprika, lycopene, elderberry, pandan, butterfly pea, and colors provided by any dye, pigment or substance that may be naturally occurring or may be synthesized or chemically modified.

Dazzling, all-natural colors from edible flowers or herbs, and unexpected crispy crunch as well as incredible flavors may be imparted to foods. A full spectrum of flavors and colors may be created for the crunchy crystal comestible product. According to an embodiment, a method of making the crunchy crystal comestible product may start by growing the most flavorful fresh herbs, or edible flowers. These are carefully hand harvested at the peak of flavor and color content, and then combined with sugar to create beautiful and flavorful crystal comestible products. The unique taste, texture and appearance add an enticing and distinctive finishing touch to creative culinary creations from desserts to savory dishes and even beverages as well as others. The comestible crystal product is shelf stable, and easy to use by merely sprinkling it onto a food item or even eaten directly to serve as a candy or other distinctive comestible or to sweeten or flavor tea and other beverages or mixed with other dried herbs, spices, sugars or salts to create unique flavor and flavoring combinations.

When the crispy crystal comestible product employs basil, the comestible product has a crispy crunchy texture and delicious sweet basil flavor to combine with a multitude of foods. The basil may be grown and harvested at the highest potency, most flavorful fresh basil leaves. When combined with sugar as the edible crystal, the just-picked basil flavor may be locked in and an attractive green color may be imparted to the resulting comestible product. A crispy crunchy texture is imparted to the resulting comestible product and has a concentrated fresh basil taste in a unique manner. The basil crystal comestible product may be used to add flavor, color and texture to desserts, fresh fruits, salads, savory dishes, beverages and others.

When the natural substance is mint, the resulting comestible product has a delicious mint flavor with a delightful unexpected crunch when eaten. The mint crystal comestible product may be used in place of conventional mint sprigs on a dessert plate. The mint crystal comestible product may be added to fresh berries, or chocolate mousse, as well as cheesecake and others. It may also be added to ice cream or sorbets. The mint crystal comestible product may be sprinkled into a cocktail beverage for a dazzling green color at the bottom of the glass that will be anticipated and then savored to the last sip. A person's palette may be cleansed with these minty green crystal comestible products.

The crispy crystal comestible product may be made with edible flowers such as fennel flower to impart a golden yellow appearance and to provide a concentrated blast of sweet anise flavor. The flower crystal comestible product pairs well with seafood like seared scallops or salmon. It may also be used with a salad to provide a highly desirable texture and flavor. The flower crystal comestible product may be sprinkled on a desert to add color, crunch and an extra layer of flavor and texture in a completely new manner. The fennel sugar crystal comestible product is very flavorful as well as colorful.

Another example of a flower crystal comestible product according to an embodiment is a rose crystal comestible product, which has a stunning, ruby-pink crystal comestible product made from rose petals and sugar. No added coloring is necessary, and the natural color from the edible rose is magnificent. With a delightful taste and the sensual aroma of fresh roses, combined with a great crunchy texture, these vibrant flavor crystal comestible products are a unique addition to any dish. It may be used in many different kinds of desserts and is very desirable when used with chocolate, on top of mini-cupcakes, canapés, sorbet, crème brûlée and others. This flower crystal comestible product adds a fresh note to fruit salads, and mixed green salads. It may be used in place of rose syrup in cocktails.

A crystal comestible product as provided herein may include one or more nutritional ingredients that add or enhance nutritional value of the product including, but not limited to minerals and trace elements such as potassium, calcium, phosphorus, magnesium, zinc, iron, manganese, copper, iodine, selenium or molybdenum, and vitamins such as thiamine (vitamin B1), riboflavin (vitamin B2), niacin (vitamin B3), pantothenic acid, biotin, pyridoxine (vitamin B6), folic acid, cobalamin (vitamin B12), ascorbic acid (vitamin C), vitamin A, vitamin D, vitamin E, vitamin K. Nutritional ingredients may be added as supplements in a purified form, or by including edible ingredients that are high in a desired nutritional ingredient such as flowers high in vitamin C or leaves high in vitamin K. Ingredients of crystal comestible products as provided herein may provide more than one feature, for example mineral salts used to form the edible crystal matrix of the product may, in addition to being comprised of minerals such as sodium, chloride, calcium, or potassium, may provide small amounts of iron, magnesium, or phosphorous, or trace elements such as iodine, copper, or selenium, and in another example, herbs or flowers may provide flavor and color as well as nutrition in the form of vitamins, minerals, or components that enhance bioavailability of other nutritional ingredients. In a non-limiting exemplary embodiment, a crystal comestible product as provided herein can be formulated as a nutritional food additive having a crispy crunchy texture.

A crystal comestible product as provided herein may include one or more nutritional or medicinal ingredients that add or enhance nutritional value or medicinal value of the product including edible substances or foods of plant, fungal, or animal origin, such as leaves, flowers, stalks, seeds, fruits, whole plants, bark, mushrooms, fish, cheese, nuts, or meat, where the edible substances or foods may be fresh or dried, e.g., basil, mint, cilantro, tarragon, oregano, rosemary, thyme, rose, fennel, hibiscus, cranberry, blueberry, apple, lemon, orange, pineapple, dried fruits, pumpkin, chocolate, vanilla, cinnamon, mace, nutmeg, sasparilla, saffron, truffle, almond, peanut, pecan, walnut, chili pepper, cheese, bacon. Edible substances or foods that add or enhance nutritional or medicinal value may also contribute to other features such as flavor, color, texture, structure, or stability of the crystal comestible product.

A crystal comestible product as provided herein may include one or more ingredients that add or enhance the structure or texture of the product, including but not limited to, ingredients that add fiber, ingredients that increase aeration, ingredients that add bulk, or ingredients that increase the contrast between textures. In a non-limiting exemplary embodiment, a crystal comestible product includes finely crushed nuts suspended in bonded sugar (sucrose) crystals, where the product has the desirable crispy crunchy texture and the texture of the crushed nuts contrasts with the texture of surrounding sugar crystals.

A crystal comestible product as provided herein may include one or more ingredients that add to or enhance stability of the product including, but not limited to, ingredients that provide an adhesive or binding function such as sugar-based food grade adhesives such as starch, cellulose, or Tylose powder (carboxymethycellulose), or non-sugar based good grade adhesives such as gelatin, gum tragacanth, guar gum, and locust bean gum. In a non-limiting exemplary embodiment, a crystal comestible product as provided herein may be made suitable for use as a “sprinkle” on top of juices, milkshakes, cocktails, fruit cups, pastries etc, by including adhesives or binders to maintain structure, and a coating such as cellulose or food grade lacquer to decrease the rate at which the product dissolves upon contact with a liquid.

A crystal comestible product as provided herein may include one or more ingredients that introduce or enhance suitability for designated uses, including, but not limited to, ingredients that alter the hygroscopic or thermal properties of a crystal comestible product. In a non-limiting exemplary embodiment, a crystal comestible product as provided herein may be made suitable for use as an “inclusion” to be incorporated and provide flavor and/or color/and/or texture in foods such as baked goods or ice cream, by including waxes or emulsifiers that affect the melting or hardening temperatures of the product. Inclusion as provided herein may be formulated to retain its flavor and color and crunchy texture, or may be formulated to melt and leave only its flavor and/or color. A blueberry-flavored crystal comestible product as provided herein could be used as an inclusion formulated so that the inclusion would melt during baking. Alternately, a blueberry-flavored crystal comestible product as provided herein could be used as an inclusion in baked goods by include coatings to prevent the product from dissolving in wet batter, and waxes or emulsifiers to stabilize the product against melting during baking. In accordance with this example, baked goods such as bagels or muffins could have blueberry-flavored crystal comestible product inclusions that remain largely structurally intact and remain crunchy.

### Sugar Crystal Comestible Product Method

Considering now an example of a method of making an embodiment of crystal comestible products, a process for making a basil comestible product will now be described. The first step is to harvesfresh basil leaves, and then lowering the temperature of the leaves to the freezing point such as to 32° F. or lower. The freezing of the leaves helps to break up the internal cellular structure to prepare for the next step of the process.

The frozen leaves are then ground to a paste. The grinding process in this example was undertaken by the use of a BLIXER® food processor. The basil paste is then refrigerated, and a quantity of granulated sugar or related substance is also lowered in temperature to the freezing point.

The cold paste and the cold sugar or related substance are then blended in a Blixer food processor, or other mixer or using other techniques. In so doing, the basil paste is partially heated and thereby releases moisture to the resulting slurry solution. The wet basil slurry solution has the consistency of wet sand and includes air spaces, entrained edible crystal material in the form of dissolved, partially dissolved, and undissolved edible crystals, and solvent particles, whereby the various crystals are combined with solvent particles and new crystals begin to form bonding the various crystals, while trapping pockets of air within.

It should be understood that the ingredients may be combined in a variety of ways as will become apparent to those skilled in the art. For example, the ingredients may, without limitation, be blended, mixed, agitated or otherwise combined.

The next step is an extruding process utilizing a filter including a ⅛ inch mesh screen, whereby the wet basil slurry solution is introduced to the mesh screen to filter out predetermined size particles. The size can be altered by utilizing different sized holes, larger or smaller if desired. This extruding or filtering process step stops or greatly inhibits further dissolution of the sugar crystals by further separating the extruded particles to allow drying.

It should be understood that there are a variety of different ways to stop or greatly inhibit further dissolution. Such ways may include, without limitation, extruding including filtering, removing moisture, and/or other such techniques.

The extruded predetermined sized particles are permitted to dry to form the comestible product. In this regard, the filtered out predetermined size particles may be spread out on a screen, or Teflon or other non-stick surface, or on a mechanized conveyer system, and then they may be subjected to air which may be heated and or dehumidified. Drying can also be achieved by blowing the air over or through the particles by using a suitable fan, heater or dehumidifier. This drying step prevents further dissolving of the sugar crystals. Thereafter, the partially dried particles may be pushed into a pile and then spread out again and/or lightly pressed or even agitated or tumbled to facilitate good separation and further drying between the individual particles. Additional heated air may be blown across or through the particles for further drying. The low humidity or heated air dries the crystals to rid the moisture therefrom, resulting in a dried light, crunchy crystal comestible product.

The resulting dried particles result in the basil sugar crystal comestible product. The product has a crunchy crispy texture due to the solvent combined with the partially dissolved sugar crystals, partially re-formed sugar crystals and air. The solvent particles impart a basil flavor to the comestible product.

The remaining portion, if any, of the slurry solution separated from the partially dissolved predetermined sized particles, may be filtered again with a finer filter to provide finer crystal comestible products which may be used for other applications such as “rimming” sugars for cocktails or other desirable applications. After the particles are dried, they may be filtered or “graded” to separate out certain sizes of particles.

A critical amount of moisture such as water or other liquid is usually important and varies with the herb or flower or even when no other flavoring or coloring agent is involved in the process. Too little water may cause the partially dissolved crystals to not combine evenly and not enough crystals dissolving. As a result, insufficient bonding may occur. If too much water is added, more dissolving of the crystal may occur than desired and air pockets may be displaced by the water. Also, it may be difficult to spread out and separate the particles during the dissolution stopping steps such as the extruding and drying steps of the process. The resulting particles may become too hard due to the lack of air spaces within the particles, and may also be fused together into an unwanted large size. Moisture may be added in various ways, including, but not limited to, pouring, spraying, introducing high-humidity air or other methods.

A method of making crystal comestible products molded into various shapes for various uses is now considered. A wet sugar (sucrose) slurry solution suitable for making particles is prepared as described above, providing a slurry solution that includes air spaces, entrained edible crystal material in the form of dissolved, partially dissolved, and undissolved edible crystals, and water, whereby the sugar in the presence of water begins to form new crystals, bonding various crystals and trapping pockets of air within the slurry mixture. The porous sugar slurry mixture is molded into various shapes and moisture is removed, yielding products that will be crunchy when eaten. In certain non-limiting embodiments, slurry mixture can be molded into special shapes, for example stars, flowers, leaves, hearts, shamrocks, happy faces, bunny rabbits, to produce molded crystal comestibles having the characteristic crunchiness, suitable for decorating cakes and pastries. The crunchy crystal comestible products will be very different from the currently available cake decorating “layons” made with sugar and additives to increase malleability, that are dense, hard, chalky, and unappetizing to eat. In other non-limiting embodiments, this technique can be used to make almost any shape desired, generating products including, but not limited to, edible spoons, edible swizzle sticks for drinks, edible coffer stirrers, edible bowls, small edible dishes, and snacks such as crackers or chips.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented

### EXAMPLES

### Example 1

### Basil Crystals

A two (2) pound batch of basil crystals was prepared using fresh basil and granulated sugar as described below. Ingredients in the amount of 20% by weight basil and 80% by weight granulated sugar (sucrose) were blended in a BLENTEC® commercial blender for about 30 seconds to form a slurry. The slurry was extruded using a ⅛ inch mesh screen, such that the extruded mixture was separated into granules. The extruded granules landed on a non-stick baking pan surface and allowed to dry on the pan surface for about 1 hour. Basil crystals were removed from the pan surface after drying.

### Example 2

### Molded Fennel Crystal Comestible Product

Ingredients in the amount of 20% fennel flowers and 80% by weight granulated sugar (sucrose) were blended in a commercial blender to form a slurry solution. The slurry solution was then poured into a silicone mold and ambient air was blown across the surface of the slurry for drying and formation of new sugar crystals. After sufficient drying, the fennel and sugar product was popped out of the mold. The resulting product was suitable for a variety of uses, including eating as a snack.

### Example 3

### Coated Molded Crystal Comestible Product

A molded crystal comestible product is produced as described above. After the product is removed from the mold, it is coated with icing, or chocolate, or caramel, colored paste, or other coating. The coated molded crystal comestible product is suitable for a variety of uses such as a “lay-on” for cake decoration, or as candy or a snack, or as an edible swizzle stick or coffer stirrer, or as an edible vessel.

What is claimed is:

1. A method of making a comestible product, comprising:
combining moisture with edible crystals;
wherein the moisture comprises a solvent; and
wherein the combining at least partially dissolves at least some of the edible crystals in the solvent to form a slurry having entrained air spaces and entrained edible crystal material;
inhibiting or stopping further edible crystal dissolution in the slurry by removing some or all of the solvent to cause formation of additional entrained air spaces; dissolved, partially dissolved, and undissolved edible crystals; and any remaining solvent to promote formation of re-formed crystals that bond together the edible crystals; and
forming re-formed crystals that bond together the edible crystals; and
wherein the inhibiting or stopping includes:
extruding the slurry to separate therefrom particles of predetermined sizes of the edible crystal material; and
drying the extruded predetermined sized particles to remove some or all moisture therefrom by one or more of the following: increasing temperature of the extruded particles, exposing the extruded particles to a vacuum, reducing humidity of the atmosphere surrounding the extruded particles, air drying the extruded particles, freeze drying the extruded particles; and blowing ambient air across a surface of the extruded particles,
wherein the combining moisture with edible crystals step further includes including adding an amount of moisture above a critical amount to prevent partially dissolved crystals to not combine evenly and not enough crystals dissolving, and below a critical amount to prevent an undesirable dissolving of the crystals and displacing air pockets with moisture; and
wherein the inhibit or stopping creates a crystalline matrix of edible crystals that is formed around the solvent and air spaces for providing the resulting comestible product with a flaky crispy airy crunchable texture to achieve a desirable mouth feel as compared to the texture and mouth feel of the undissolved edible crystals.

2. A method according to claim 1, wherein the moisture further includes non-solvent components, the method further comprising removing some or all of the additional non-solvent components from the matrix.

3. A method according to claim 1, wherein the moisture includes water as a solvent for the edible crystals.

4. A method according to claim 1, wherein the moisture further includes ethanol as a solvent for the edible crystals.

5. A method according to claim 1, comprising using a mesh, sieve, or screen having a predetermined pore size for extruding the slurry, to produce particles of predetermined size.

6. A comestible product made by the method of claim 1.

7. A crystal comestible product comprising:
an edible crystal matrix created using an edible crystal and a solvent that form a slurry solution having entrained air spaces, entrained edible crystal material in the form of dissolved, partially dissolved, and undissolved edible crystals, and solvent,
wherein said edible crystal matrix comprises air pockets trapped within the matrix during preparation of the slurry solution, and free space created by removing some or all of the solvent during drying to form a crispy crunchy comestible product.

8. A crystal comestible product according to claim 7, wherein the solvent particle includes a moisture containing substance to add flavor to the product crystal.

9. A crystal comestible product according to claim 8, wherein the flavor is selected from the group consisting of chocolate flavor, vanilla flavor, coffee flavor, herb flavor, flower flavor, spice flavor, and nut flavor.

10. A comestible product according to claim 7, wherein the edible crystal is one selected from the group consisting of salt and sugar.

11. A comestible product according to claim 7, further comprising ingredients that add or enhance features selected from the group consisting of flavor, color, nutritional value, text, structure, and stability.

12. A comestible product according to claim 11, comprising an ingredient that adds or enhances flavor selected from the group consisting of edible flowers, herbs, cocoa, spices, and combinations thereof.

13. A comestible product according to claim 12, wherein the herbs are selected from the group consisting of basil, fennel, and mint.

14. A comestible product according to claim 11, comprising an ingredient that adds or enhances nutritional value selected from the group consisting of vitamins, minerals, fruits, and nuts.

15. A method according to claim 1, wherein the combining further includes one or more of the following additional ingredients comprising flavor enhancing substances, flowers, nutritional ingredients, medicinal ingredients, structure or texture ingredients, stabilizers, and ingredients for suitability for designated uses.

16. A method according to claim 1, wherein the edible crystals are one selected from the group consisting of salt and sugar.

17. A method according to claim 16, further comprising adding ingredients that add or enhance features selected from the group consisting of flavor, color, nutritional value, texture, binding, structure, stability, and combinations thereof.

18. A method according to claim 17, wherein the ingredient that adds or enhances flavor selected form the group consisting of edible flowers, herbs, cocoa, spices, and combinations thereof.

19. A method according to claim 18, wherein the herbs are added in the form of herb leaves, the herb leaves being frozen and then grinding them into a paste, lowering the temperature of the paste and the crystals prior to the combining of them.

20. A method according to claim 1, further including adding an amount of moisture above a critical amount to prevent partially dissolved crystals to not combine evenly and not enough crystals dissolving, and below a critical amount to prevent an undesirable dissolving of the crystals and displacing air pockets with moisture.
